(19) United States
(12) Patent Application Publication
(10) Pub. No.: US 2011/0203468 A1
(43) Pub. Date: Aug. 25, 2011

(54) PRINTING ROLL AND METHOD OF PRODUCING THE SAME

(75) Inventors: Yoshio Harada, Hyogo (JP); Takema Teratani, Hyogo (JP)

(73) Assignee: TOCALO CO., LTD., Hyogo (JP)

(21) Appl. No.: 13/127,740

(22) PCT Filed: Nov. 5, 2009
(86) PCT No.: PCT/JP2009/069234

§ 371 Date: May 5, 2011

(30) Foreign Application Priority Data
Nov. 11, 2008 (JP) 2008-288827
Mar. 27, 2009 (JP) 2009-078054

(51) Int. Cl. B41F 13/10; B41C 3/00

(52) U.S. Cl. 101/375; 101/401.1

(57) ABSTRACT

In order to propose a dry process technique of producing a printing roll having safe and beauty concave portions for printing image area without discharging environmental contaminating substance and a new technique for improving quality of printed matters, this invention is to provide a printing roll with DLC film layer in which laser beam-engraved grooves as concave portions for printing image area are formed on a carbide cermet spray coating formed on a surface of a roll substrate, and a method wherein a carbide cermet spray coating is formed on a surface of a roll substrate roughened by a blast treatment, the surface of the carbide cermet spray coating is ground or ground-polished, then a DLC film is formed on the ground or ground-polished surface and thereafter laser beam-engraved grooves are formed on the surface of the DLC film as a concave portion for printing image area.

### TECHNICAL FIELD

This invention relates to a printing roll such as gravure engraving roll or the like, which is provided by directly forming laser beam-engraved grooves as a concave portion for printing image area on a surface of a diamond-like carbon membrane as an outermost layer, and a method for producing the same.

### RELATED ART

Generally, the printing system can be divided into five systems of letterpress, lithography, intaglio, stencil and non-plate. The printing roll aimed at the present invention, for example, gravure engraving roll belongs to the intaglio, and is used in a printing system wherein an ink adhered to concave portions for printing image area are transferred to a paper after the ink is scraped out from non-image area. As a printing surface, those having 175 screening lines (printing elements) per 1 inch and a depth of a concave portion (cell) of about 2.5-30 μm are frequently used.

On the other hand, almost of printing inks are oil-based or water-based ones containing inorganic pigment or organic pigment. A basic composition of the ink is fine particles of a coloring pigment and is added with a polymer adhesive mass for equally transferring these fine particles to an objective to be printed, a solvent for imparting fluidity, transferring property and dryness to the ink, an auxiliary agent for suppressing ink bubbling to prevent generation of static electricity.

As the solvent of the oil-based ink, toluene, xylene, ethyl acetate, propyl acetate, methyl ethyl ketone and so on are used, while water, ethanol, propanol and so on are mainly used in the water-based ink. The solvents for the oil-based ink such as toluene, xylene, methyl ethyl ketone and the like are strong in the irritating odor, low in the flash point and high in the volatility, high in the risk of ignition and explosive and are absorbed by human bodies to induce health damage, so that they have significant problems in both of the safety and health. However, papers printed by the oil-based ink are excellent in the gloss and beauty in the appearance, so that they are widely put into practice and can not be completely removed from the printing field.

The water-based ink basically uses water and alcohol, so that it has an excellent advantage in the safety and hygiene as compared with the oil-based ink, but it is common that the quality of the printed matter is poor as compared with those of the oil-based ink.

In case of most common gravure engraving roll among printing rolls, a copper plated layer for the formation of printing surface is formed on a surface of a hollow roll made from an aluminum alloy or a stainless steel and thereafter a surface thereof is further subjected to a hard chromium plating to thereby improve the printing force of the etched copper plated layer. However, the hard chromium plating typically uses a plating bath containing hexavalent chromium, so that it is unfavorable in the working safety and is represented to be a source of environmental pollutant.

As a conventional countermeasure, JP-A-H04-282296, JPA-2002-172752, JP-A-2000-10300 and JP-A-2002-178653 propose a method wherein the surface of the etched copper plated layer as an image forming surface (printing pattern grooves) is coated with a diamond-like carbon film (hereinafter referred to as “DLC film”) instead of the chromium plating. Also, JP-A-H11-309950, JP-A-H11-327124 and JP-A-2000-15770 propose a technique wherein a layer of rubber or a resin is formed on a surface of the hollow roll and thereafter a surface thereof is engraved as a printing area and the DLC film is formed thereon, and JP-A-2007-130996 proposes a technique wherein a layer of a metal of W, Si, Ti, Cr or the like or a carbide thereof with a thickness of less than 1 μm is formed on the surface of the copper plated layer by sputtering method for improving the adhesion property of the DLC film to the etched copper plated layer and thereafter the DLC film is coated thereon.

### DISCLOSURE OF THE INVENTION

### Problems to be Solved by the Invention

The conventional gravure engraving roll having the DLC film as mentioned above is merely adopted for protecting the copper plated layer to be etched or the chromium plating subjected to the surface of the copper plated layer or the sputtered layer of tungsten, titanium, chromium or a carbide thereof though the DLC film is used. In JP-A-H04-282296, JP-A-2002-172752, JP-A-2000-10300 and JP-A-2002-178653, the DLC film is used only for protecting the etched copper plated layer, so that there is a problem that the properties inherent to the DLC film can not be developed.

It is, therefore, an object of the invention to propose a printing roll wherein concave portions for sharp printing elements can be maintained over a long time of period by applying the DLC film, which is not used as a protection membrane but is used as a printing plate itself, to gravure printing but also the concave portions having excellent printing characteristics can be engraved and further are excellent in the working properties, maintenance, printing plate life and so on.

It is another object of the invention to propose a method for producing a printing roll wherein the roll is produced by a dry process instead of a wet process including a copper plating step and a chromium plating step as a source of environmental pollutant and is excellent in not only the environment but also the safety and hygiene of workers.

### Means for Solving Problems

The inventors have made various studies for solving the above problems of the conventional techniques and found that the above problems can be solved by the following means.

The invention lies in a printing roll comprising a roll substrate, a carbide cermet spray coating formed on the surface of the roll substrate and a DLC film layer formed on the surface of the carbide cermet spray coating and having laser beam-engraved grooves as a concave portion for printing image area.

In the printing roll according to the invention, the followings are preferable means:

(1) The DLC film is provided with hydrophilicity by including 0.1-22 atomic % of fine oxide particles of at least one metal selected from Si, Y, Al and Mg;

(2) The DLC film has a thickness of 3-50 μm, a chemical composition of carbon: 70-88 atomic % and hydrogen: 12-30 atomic % and a hardness Hv of 700-3000;

(3) The DLC film having laser beam-engraved grooves has a residual stress of less than 1.0 GPa;

(4) The DLC film has Ra≦0.013 μm and Rz≦0.16 μm as a roughness of a finish polished surface;

(5) The carbide cermet spray coating contains 95-70 mass % of at least one metal carbide selected from WC, TiC, Cr₃C₂ and MoC and 5-30 mass % of at least one metal selected from Ni, Cr, Mo, Co and Al.

In the printing roll according to the invention, the followings are more preferable means:

(6) A surface roughness of the roll substrate roughened by blast process is adjusted to Ra: 5-12 μm and thereafter a carbide cermet spray coating containing 95-70 mass % of at least one metal carbide selected from WC, TiC, Cr₃C₂ and MoC and 5-30 mass % of at least one metal selected from Ni, Cr, Mo, Co and Al is formed on the roughened surface;

(7) The surface of the carbide cermet spray coating is made to Ra: 0.05-8.00 μm and Rz: 0.5-20 μm by grinding or grinding-polishing.

Also, the invention proposes a method for producing a printing roll, which comprises roughening a surface of a roll substrate by blast process; forming a carbide cermet spray coating on the roughened surface by spraying process; grinding or grinding-polishing the surface of the carbide cermet spray coating; forming a DLC film on the ground or ground-polished surface of the carbide cermet spray coating; and engraving the surface of the DLC film through laser beams to form laser beam-engraved grooves as a concave portion for printing image area.

In the production method of the printing roll, the followings are preferable means:

(1) The DLC film is provided with hydrophilicity by including 0.1-22 atomic % of fine oxide particles of at least one metal selected from Si, Y, Al and Mg;

(2) A surface roughness of the roll substrate roughened by blast process is adjusted to Ra: 5-12 μm and thereafter a carbide cermet spray coating containing 95-70 mass % of at least one metal carbide selected from WC, TiC, Cr₃C₂ and MoC and 5-30 mass % of at least one metal selected from Ni, Cr, Mo, Co and Al is formed on the roughened surface;

(3) The surface of the carbide cermet spray coating is made to Ra: 0.05-8.00 μm and Rz: 0.5-20 μm by grinding or grinding-polishing;

(4) The DLC film has a thickness of 3-50 μm, a chemical composition of carbon: 70-88 atomic % and hydrogen: 12-30 atomic % and a hardness Hv of 700-3000;

(5) The surface of the DLC film is finish polished to approximately a roughness of Ra≦0.013 μm and Rz≦0.16 μm;

(6) The DLC film is engraved as a concave portion for printing image area with a heat source of at least one laser beam selected from CO₂ laser, YAG laser, Ar laser and excimer laser;

(7) The DLC film has a residual stress of less than 1.0 GPa.

### Effects of the Invention

According to the invention, the aforementioned DLC film is used as an image forming layer of the printing roll or an engraved layer of concave portions for printing image area, so that the following effects can be expected:

(1) Since the DLC film is typically hard and excellent in the abrasion resistance, when it is used as an image forming layer of the printing roll, laser beam-engraved grooves as a concave portion for printing image area (engraving surface) can be used over a long time of period without losing the shape;

(2) The DLC film having laser beam-engraved grooves as the concave portion for printing image area has a smooth surface and is excellent in the abrasion resistance, so that it is small in the contact resistance with a printing paper and can increase the printing rate;

(3) When the surface of the DLC film is engraved by laser beams to form the concave portions for printing image area, portions irradiated with laser beams are emitted into air as a gas such as CO₂, H₂O or the like, so that accurate and beauty engraved grooves can be formed without generating minute fused agglomerates and the quality of the printed matter is improved.

(4) Since the rate of engraving the surface of the DLC film through laser beams is very fast, the production efficiency is improved but also the removal of the DLC fim after use is easy. Further, the members other than the DLC film can be used repeatedly, so that an economical and environmentally-friendly technique can be provided.

(5) The DLC film is formed on the surface of the roll substrate through the intermediate layer made of the carbide cermet spray coating instead of the direct formation, so that even if a large load is applied to the thin DLC film during the printing, the shape of the laser beam-engraved grooves (concave portions for printing image area) is never deformed or buckled.

(6) Since the carbide cermet spray coating having an excellent adhesion property to the roll substrate and the DLC film consisting essentially of carbon and hydrogen is used as the intermediate layer, even if large load is applied to the DLC film in the printing, the film is never peeled off.

(7) Even if the roll substrate is copper and copper alloy, aluminum and aluminum alloy, or nickel and nickel alloy, which is not suitable for the formation of the DLC film, it is possible to form the good DLC film by interposing the intermediate layer made of the carbide cermet spray coating, so that the degree of freedom in the material selection of the roll substrate becomes large.

(8) Since the DLC film formed by using a hydrocarbon-based gas is lipophilic in nature, it is suitable for the use of oil-based printing inks. In the invention, however, it is possible to impart hydrophilicity to the surface of the DLC film by co-precipitating fine particles of the metal oxide into the film, so that it can be used in both the oil-based and water-based printing inks.

(9) In the method according to the invention, the film is not formed by using the chemicals having a large environmental load such as copper plated layer or chromium plated layer, or the etching engraving method with such a chemical is not used, so that the environmental load can be reduced but also there can be provided a production process being excellent in the safety and hygiene of workers.

### BRIEF DESCRIPTION OF THE DRAWINGS

FIG. 1 is a partially enlarged section view of a surface layer of a gravure engraving roll according to the invention;

FIG. 2 is a flow chart for producing a gravure engraving roll according to the invention;

FIG. 3(a) is a section view of a DLC film when Rz value as a surface roughness of a spray coating is large, and (b) is a section view of a DLC film applied on a surface of a spray coating having small Ra and Rz values;

FIG. 4 is a schematic view of a plasma CVD apparatus for the formation of a DLC film;

FIG. 5 is a schematic view illustrating a method of measuring residual stress of a DLC film;

FIG. 6 is an enlarged SEM image in a section of a DLC film co-precipitated with fine particles of SiO₂;

FIG. 7 is an enlarged SEM image in an appearance of a DLC film surface engraved by laser beams;

FIG. 8 is an enlarged view of scratch traces remaining on a DLC film surface after scratch test; and

FIG. 9 is a sketch of an appearance evaluated on a water wettability of a DLC film formed on a surface of a test specimen.

(a) shows a distribution state of water droplets fallen onto a lipophilic DLC film;

(b) shows a distribution state of colloidal silica powder remaining on a DLC film after evaporation of water droplets of the state (a);

(c) shows a distribution state of water droplets fallen onto a hydrophilic DLC film;

(d) shows a distribution state of colloidal silica powder remaining on a DLC film after evaporation of water droplets of the state (c).

### DESCRIPTION OF REFERENCE NUMERALS

1 Engraving roll substrate
2 Carbide cermet spray coating
3 DLC film
4 Laser beam-engraved groove (concave portion for printing image area)
31 Carbide cermet spray coating
32 Surface roughness represented by Ra
33 Surface roughness represented by Rz
34 DLC film
35 Convex portion not covered with DLC film and having a roughness represented by Rz
41 Reaction vessel
42 Printmaking roll (body to be treated)
43 Conductor
44 High-voltage pulse generating power source
45 Plasma generating power source
46 Superimposed device
47a, 47b Valve
48 Ground wire
49 High-voltage lead-in terminal
91 Substrate
92 DLC film
93 DLC film containing SiO₂ particles
94 Aqueous slurry polishing agent containing colloidal silica
95 Remaining colloidal silica powder

### EMBODIMENTS OF THE INVENTION

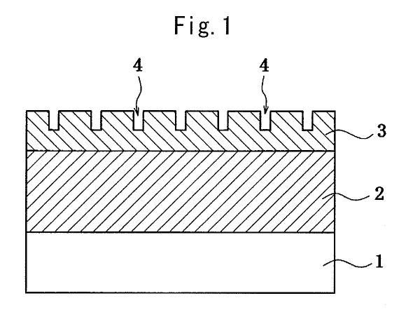

FIG. 1 shows a portion of a surface layer in a typical gravure engraving roll as a printing roll according to the invention as an enlarged section view. In this figure, numeral 1 is a roll substrate, numeral 2 a carbide cermet spray coating formed on the surface of the roll substrate by spraying process, and numeral 3 a DLC film formed on the surface of the spray coating as an outermost layer of the gravure engraving roll and having laser beam-engraved grooves 4 formed as a concave portion for printing image area (cell) by laser beam work, in which the DLC film is used as a so-called printing surface (printmaking layer).

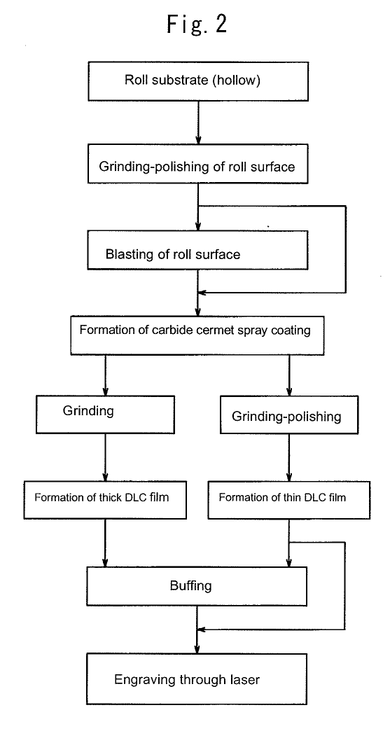

FIG. 2 shows production steps for a printing roll according to the invention (which will be described with respect to “gravure engraving roll” hereinafter). The production method according to the invention will be described with reference to this figure below.

(1) Grinding, Grinding-Polishing Step of Roll Surface;

As a substrate for the gravure engraving roll can be used a pipe wherein an inside of the roll is hollowed for weight saving. In general, this engraving roll is finished to have a surface roughness Ra of about 5-12 μm by grinding or grinding-polishing the surface with a lathe or a polishing machine. As a material of the roll substrate are preferable Al and Al alloy, Ti and Ti alloy, and so on, but cast iron and carbon steel (including alloyed steels such as stainless steel) may be used. Also, composite materials reinforced with plastic or glass fibers or carbon fibers may be used. In case of cast roll, cast cavities may be generated in the roll surface, so that they are repaired by spot welding, a method of embedding metal pins or the like in advance.

(2) Step of Blasting Roll Surface;

The surface of the roll substrate subjected to grinding or grinding-polishing is subjected to blasting with Al₂O₃ grids to render into a given roughened state. If a high-speed flame spraying method is applied at a subsequent step of forming a spray coating, a flying speed of hard spraying particles becomes large (for example, not less than 300 m/s), so that the roughening treatment with blasting may be omitted. Because, when hard carbide cermet spraying particles come into collision with the roll surface at a large flying speed, they stick on the surface of the substrate to form a coating having a strong adhesion force.

(3) Step of Forming Spray Coating;

In the invention, a spray coating of carbide cermet is formed on the surface of the roll substrate prior to the formation of DLC film as a surface for printing image area. As a carbide used are preferable WC, TiC, Cr₃C₂, MoC and so on as a single or composite carbide, and hard WC and WC—Cr₃C₂ are particularly preferable. As a metal component is included 5-30 mass % of at least one metal selected from Ni, Cr, Mo, Co and Al. In case of the single carbide, it is difficult to form a coating having a good adhesion property by the spraying method, and if the coating is formed, it is porous and unsuitable as a ground layer for DLC film. In case of the cermet spraying powder material formed by adding the metal component to the carbide, the metal component is fully fused in a hot spraying source to improve a joining force to the roll substrate and to enhance mutual bonding force among particles constituting the coating, while the generation of pores is suppressed in minimum. Moreover, the size of the carbide cermet spraying particles is preferable to be a range of 5-70 μm as a particle size. When the particle size is less than 5 μm, it is difficult to continuously and equally feed the particles to a spraying gun, while when it exceeds 70 μm, the particles are not completely fused in the hot spraying source and hence the resulting coating is liable to be porous.

In the formation of the carbide cermet spray coating, a plasma spraying method in air, a plasma spraying method under a reduced pressure, a high-speed flame spraying method, an explosive spraying method and the like are preferable, and the high-speed flame spraying method is particularly preferable. In the high-speed flame spraying method, the temperature of the hot spraying source is relatively low (1800-2200° C.), but the speed is not less than 1000/s, so that the change of properties due to thermal decomposition of the carbide can be suppressed but also large kinetic energy is applied to the spraying particles and hence these particles can be adhered and deposited with strong impact force to form a dense coating.

The thickness of the carbide cermet spray coating is preferably a range of 30-200 μm. When the thickness of the coating is less than 30 μm, it is liable to easily form a coating having partially many pores and it is difficult to obtain an equal coating. While, when the thickness exceeds 200 μm, remarkable effects are not obtained as a ground coating for DLC film and the production cost is rather increased.

(4) Step of Finishing Surface of Carbide Cermet Spray Coating;

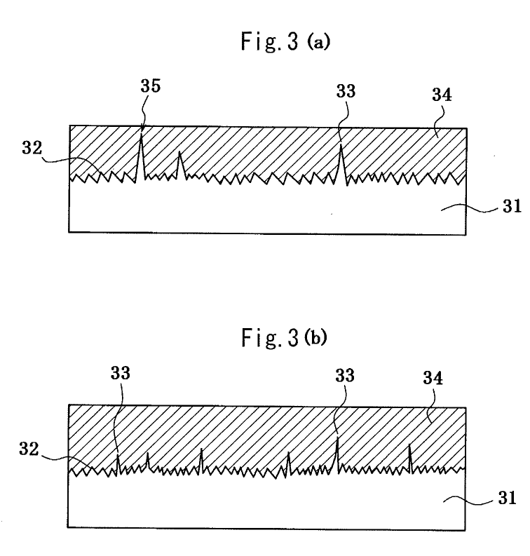

In this step, the surface of the carbide cermet spray coating is ground with a diamond-based grind stone or a polishing agent or finished into a mirror state by polishing after the grinding. The finishing degree of the surface of the carbide cermet spray coating in this step exerts a large influence on the effect of DLC film at subsequent step. The surface roughness of the spray coating through this step can be made to ranges of Ra: 0.05-8.00 μm and Rz: 0.5-20 μm, but it is particularly important to control Rz. For instance, FIG. 3 schematically shows a section when DLC is formed directly on the ground or ground-polished surface of the spray coating. FIG. 3(a) shows a state that a projection 35 protruding toward the surface of the DLC film is existent or a projection 33 arriving near to the vicinity of the surface is existent since Rz value is high though Ra value is low. The DLC film applied onto such a rough surface is easily influenced by the projections 33, 35 when it is engraved through laser beams, so that good engraved surface is not obtained. On the other hand, FIG. 3(b) shows that the DLC film applied to the surface having low Ra and Rz values is a film not exerted by the influence of the ground layer. In FIG. 3(b), the height of the projection 33 indicating Ra value is less than about 50% of the thickness of the DLC film. Therefore, it is preferable to conduct laser beam engraving for the formation of concave portion for printing image area by irradiating laser beams to the DLC film at such a state. In this figure, 31 is a carbide cermet spray coating, 32 a surface roughness represented by Ra, 33 a surface roughness represented by Rz, 34 a DLC film, and 35 a projection not coated by the DLC film and having a roughness represented by Rz.

In general, when large area, boldfaces, large numerical symbols and so on are printed in the gravure printing, even if the surface roughness of the spray coating has approximately Ra=0.05-8.00 μm and Rz=0.5-20 μm, good laser beam-engraved grooves are obtained as long as the thickness of the DLC film formed on the coating is not less than 40 μm. Conversely, when printing precise small letters, numerical symbol and lines, the surface roughness of the spray coating is finished into ranges of Ra=0.05-0.8 μm and Rz=0.5-1.5 μm and the DLC film is formed on such a surface at a thickness of 3-5 μm.

As mentioned above, it is necessary that the surface of the carbide cermet spray coating for forming the DLC film adopted in the invention is finished so as to render into a thickness corresponding to two times or more Rz value of the surface roughness.

(5) Step of Forming DLC Film;

This step is a treatment that DLC film adapted in the invention is formed on the ground or ground-polished surface of the carbide cermet spray coating. The DLC film formed on the spray coating surface according to the invention can be formed by any method such as an ionization deposition method, an arc ion plating method, a plasma buster method and a high-frequency, high-voltage pulse superimposed type plasma CVD method (referred to as “plasma CVD method” hereinafter). The followings are concretely explained with respect to plasma CVD method suitable for the formation of thick film and an apparatus thereof.

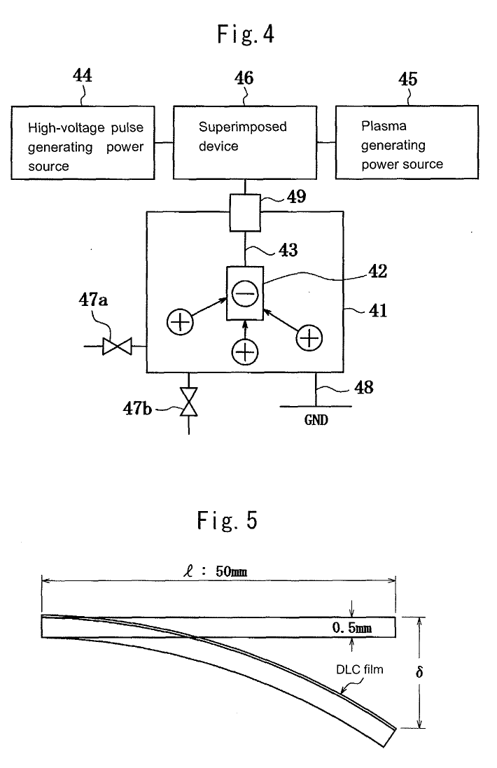

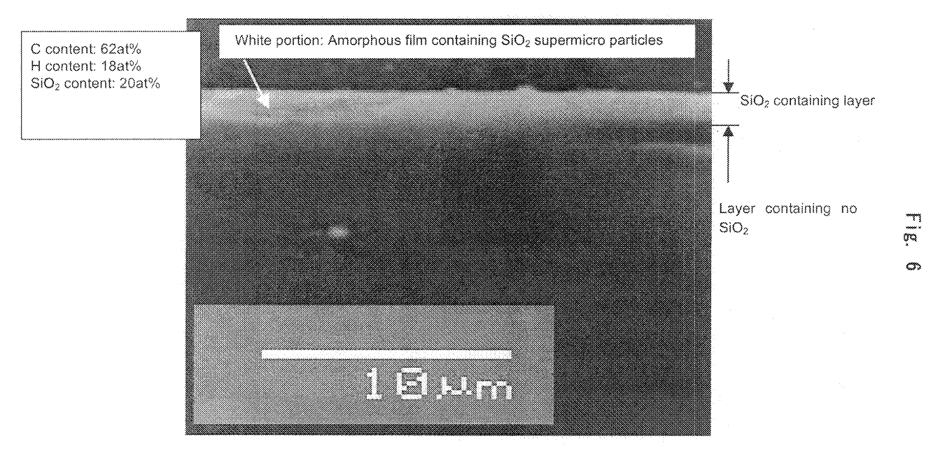

FIG. 4 is a schematic view illustrating an example of plasma CVD apparatus used for forming the DLC film on the surface of the roll substrate provided with the carbide cermet spray coating produced through the steps as previously mentioned. In the plasma CVD apparatus are mainly disposed a reaction vessel 41 connected to ground, a high-voltage pulse generating power source 44 for applying high-voltage pulses to the reaction vessel 41 and a plasma generating power source 45 for generating hydrocarbon-based gas plasma around a body to be treated (which is called as “printmaking roll” hereinafter). In addition, a superimposed device 46 for simultaneously applying both of high-voltage pulse and high-frequency voltage to a conductor 43 and the printmaking roll 42 is interposed between the high-voltage pulse generating power source 44 and the plasma generating power source 45. Moreover, the conductor 43 and the printmaking roll 42 are connected to the superimposed device 46 through a high-voltage introduction part 49.

In the plasma CVD apparatus, a gas introduction device for introducing an organic gas for the formation of the film into the reaction vessel 41 (not shown) and a vacuum device for vacuuming the reaction vessel 41 (not shown) are connected to the reaction vessel 41 through valves 47a and 47b, respectively.

In order to form the DLC film on the surface of the body to be treated using the plasma CVD apparatus, the printmaking roll 42 is first placed in a given position inside the reaction vessel 41, and the vacuum device is actuated to discharge air from the inside of the reaction vessel 41, and then an organic gas is introduced into the reaction vessel 41 through the gas introduction device.

Then, a high-frequency voltage is applied from the plasma generating power source 45 to the printmaking roll 42. Since the reaction vessel 41 is electrically a neutral state through a ground wire 48, the printmaking roll 42 becomes relatively negative potential, and hence plus ions in the plasma are generated around the negatively charged printmaking roll 42.

When high-voltage pulses (negative high-voltage pulses) are applied from the high-voltage pulse generating power source 44 to the printmaking roll 42, plus ions in the plasma of the introduced organic gas are attracted and adsorbed onto the surface of the printmaking roll 42. Onto the surface of the printmaking roll 42 is formed a DLC film by such a treatment. Namely, it is considered that a DLC film of amorphous hydrocarbon solid consisting of carbon hydrogen as a finally main component is precipitated in vapor phase around the printmaking roll 42 to form a DLC film coating therearound.

Moreover, the inventors have presumed that the DLC film of amorphous hydrocarbon solid formed by the above plasma CVD apparatus is produced through the following processes (a)-(d):

(a) the ionization of the introduced hydrocarbon gas is caused (neutral particles called as radical are also existent);

(b) the ions and radicals changed from the hydrocarbon gas are impulsively collided to the negatively charged surface of the printmaking roll 42;

(c) C—H bond having a small bonding energy is cut by energy in the collision and thereafter activated C and H repeat polymerization reaction to form a polymer, whereby amorphous hydrocarbon solid consisting essentially of carbon and hydrogen is precipitated in vapor form; and

(d) the DLC film made of a deposited layer of amorphous hydrocarbon solid is formed on the surface of the printmaking roll 42 by the above reaction (c).

Moreover, ion implantation of a metal or the like to the printmaking roll 42 may be conducted by varying an output power of the high-voltage pulse generating power source 44 in the above apparatus to the following (a)-(d):

(a) case of heavily conducting ion implantation: 10-40 kV;

(b) case of conducting both ion implantation and coating formation: 5-20 kV;

(c) case of conducting only coating formation: several hundred V to several kV;

(d) case of heavily conducting sputtering or the like: several hundred V to several kV.

In the high-voltage pulse generating power source 44, it is possible to repeatedly generate pulses having a pulse width of 1 μmsec-10 msec and a pulse number of 1-plural times.

Also, the output frequency of high-frequency voltage from the plasma generation power source 45 may be varied in a range of several ten kHz to several GHz.

As the organic gas for the formation of the film introduced into the reaction vessel 41 in the plasma CVD apparatus are used hydrocarbon-based gases each consisting essentially of carbon and hydrogen as shown in the followings (i)-(iii) and organic metal compounds obtained by adding at least one of Si, Al, Y and Mg thereto:

(i) CH₄, CH₂CH₂, C₂H₂, CH₃CH₂CH₃, CH₃CH₂CH₂CH₃ of vapor phase at room temperature (18° C.);

(ii) C₆H₅CH₃, C₆H₅CH₂CH, C₆H₄(CH₃)₂, CH₃(CH₂)₄CH₃, C₆H₁₂, C₆H₄Cl of liquid phase at room temperature;

(iii) Organic Si Compounds (Liquid Phase)

(C₂H_{S}O₂)₄Si, (CH₃O)₄Si, [(CH₃)₄Si]₂O

As the gas introduced into the reaction vessel 41, the gas of vapor phase at room temperature can be introduced into the reaction vessel 41 as it is, whereas the compound of liquid phase is gasified by heating and the resulting gas (steam) is supplied to the reaction vessel 41, whereby the DLC film can be formed.

Moreover, the DLC film formed on the ground or ground-polished surface of the carbide cermet spray coating has the following properties:

(a) Ratio of Carbon and Hydrogen Contents Constituting DLC Film

The DLC film is hard and excellent in the abrasion resistance, but generates a large residual stress in the film formation, so that the flexibility is lacking. Therefore, if local fine defects are caused in the DLC film or slight engraved difference is locally generated during the engraving through laser, the DLC film is apt to be easily peeled off due to the residual stress, so that it is important to mitigate the residual stress.

As a countermeasure, the invention draws attention to the ratio of carbon and hydrogen constituting the DLC film, and particularly the hydrogen content is controlled to 12-30 atomic % as a whole to thereby impart the abrasion resistance and flexibility to the DLC film. Concretely, the hydrogen content included in the DLC film is made to 12-30 atomic %, while the reminder is the carbon content. The formation of the DLC film having such a composition can be attained by mixing a compound having a different hydrogen content occupied in the hydrocarbon gas for the formation of the film.

Moreover, the DLC film having the aforementioned hydrogen content has a micro-Vickers hardness of Hv: 700-3000 as a surface hardness, so that it is far soft and has a flexibility withstanding to a certain deformation as compared with DLC films formed on tool steels and the like.

(b) Residual Stress of DLC Film Suitable for Engraving with Heat Source of Laser Beams

In the DLC film of solid phase state precipitated from the hydrocarbon gas of vapor phase is necessarily caused residual stress. In the DLC film having a large residual stress, the thicker the film thickness, the larger the residual stress, so that the residual stress is finally larger that the adhesion strength of the film, resulting in the peeling of the DLC film. At the present, many kinds of apparatuses are developed as the method of forming the DLC film, but one of the applied conditions is a limit thickness determined by the residual stress of the resulting DLC film.

Even if the DLC film having a relatively thick thickness is formed, the residual stress concentrates into concave portions of the film formed by engraving through laser beams, and hence the DLC film is locally broken or peeled off, so that it is very important to determine an optimal value of the residual stress in the DLC film.

From the reasons as mentioned above, the inventors measured the residual stress of the DLC film by the following method. The evaluation of the residual stress of the DLC film is carried out by forming a DLC film on a reed-shaped thin quartz substrate (size: width 5 mm×length 50 mm×thickness 0.5 mm) fixed to one end of a test specimen and measuring displacement amount (δ) of the quartz substrate before and after the film formation to determine the residual stress of the film, and concretely the residua stress (σ) is calculated according to the following Stoney equation:

$$σ = \frac{E \cdot {b}^{2}}{3 ( 1 - v ) \cdot {l}^{2} \cdot d} δ$$

E: Young's modulus of substrate=76.2 GPa

v: Poisson's ratio of substrate=0.14

b: thickness of substrate=0.5 mm

l: length of substrate formed with DLC film

δ: displacement amount

d: thickness of DLC film

Table 1 shows a summary of residua stress values of various DLC films determined by the above method. As seen from the results, the residual stress of the DLC film formed by a method such as arc ion plating method, ionization deposition method or the like is 10-18 GPa, while the residual stress of the DLC film formed by plasma CVD method is as very low as 0.30-0.98 GPa.

Moreover, when the maximum forming thickness of the DLC film is attempted in this test, in the plasma CVD method, the film forming time becomes longer, but the film having a thickness of 50 μm was formed. However, in the other film formation, it is difficult to form the film having the thickness of not less than 3 μm.

TABLE 1

| | | | Formable | |
|---|---|---|---|---|
| | Method of | Residual | thickness of | Kind of gas |
| | forming DLC | stress | film | for film |
| No. | film | (GPa) | (μm) | formation |
| 1 | Plasma CVD | 0.35-0.98 | not more than | C₂H₂ |
| | method | | 50 | C₆H₅CH₃ |
| 2 | Arc ion | 15-20 | not more than | C (solid) |
| | plating | | 3 | |
| | method | | | |
| 3 | Ionization | 13-18 | not more than | C₂H₂ |
| | deposition | | 3 | C₆H₅CH₃ |
| | metrics | | | |

(c) The DLC film formed by the method of the invention is possible to be immediately subjected to engraving through laser beams. However, in the invention, in order to properly cope therewith in accordance with the nature of the printing ink, it is designed that hydrophilicity is imparted to the surface of the DLC film so as to develop sufficient wettability against water soluble printing inks. That is, metal fine particles are co-precipitated into the DLC film obtained by the above method and further oxidized to form fine particles of metal oxide, whereby the surface is changed into a surface having a hydrophilicity to improve the wettability to the water-soluble printing ink.

In general, when amorphous-like DLC film itself containing no metal oxide is formed by any one of the above plasma CVD method, ionization deposition method, arc ion plating method and plasma buster method, the surface of the DLC film indicates lipophilicity, so that the wettability with the oil-based ink is good, but there is a tendency that the wettability with the water-soluble printing ink adopted as a good printing ink for environment is bad, which is a large possibility of causing the decrease of quality in the printed matters.

According to the invention, therefore, those containing the organic metal compound is used as a starting material for the formation of the DLC film or an organic gas for the film formation. In the DLC film formed by the method using the organic metal compound gas, fine particles of the metal are co-precipitated and changed into fine particles of metal oxide, whereby hydrophobicity can be changed into hydrophilicity.

The method of forming DLC film while co-precipitating metal fine particles will be concretely described below.

The kind of the gas introduced into the reaction vessel 41 shown in FIG. 4 is a hydrocarbon gas comprised of carbon and hydrogen as well as an organic metal compound obtained by bonding a given element (at least one metal selected from Si, Al, Y, Mg and the like or an alloy thereof) thereto.

As an example of the organic metal compound gas, for example, if it is intended to precipitate fine particles of Si, (C₂H_{S}O)₄Si, (CH₃O)₄Si, [(CH₃)₃Si] and the like are preferable. On the other hand, in order to precipitate Al, Y, MG or the like, a gas with a composition of Al, Y, Mg added instead of Si in the above-mentioned organic metal compound may be used. Also, even in case of using the organic metal compound formed by adding an element such as Si, Al, Y, Mg or the like to (C₁₁H₁₉O₂) group or (C₁₂H₂₁O₂) group, amorphous film consisting essentially of carbon and hydrogen and dispersedly containing an element such as Si, Al, Y, Mg or the like can be formed. Moreover, the organic compound gas of vapor phase at room temperature can be introduced into the reaction vessel 41 as it is, but the compound of liquid phase is gasified by heating and the resulting steam supplied to the reaction vessel 41. When amorphous film is formed by using the organic Si compound gas, fine particles of Si are co-precipitated and incorporated into the film and there is particularly a possibility that a part of Si is strongly bonded to carbon to produce SiCx, which does not obstruct the function and effects of the invention.

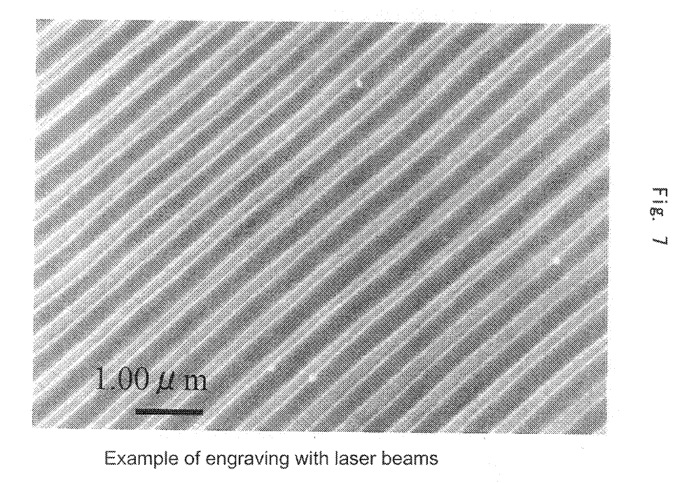

The particle size of the metal particles in the DLC film co-precipitated by using the above organic metal compound gas is Si≈2.34 Å (2.34×10⁻¹⁰ m), Al≈2.86 Å (2.86×10⁻¹⁰ m), Y≈3.64 Å (3.64×10⁻¹⁰ m), Mg≈3.20 Å (3.20×10⁻¹⁰ m), so that these fine particles are difficult to be determined by not only an optical microscope but also an electron microscope as shown in FIG. 6 and do not affect the printing.

As the method of oxidizing the metal fine particles co-precipitated in the DLC film, there may be mentioned the following methods;

(a) the particles are heated in an oxygen gas or in a gas atmosphere containing oxygen gas; and

(b) they are oxidized by an oxygen gas plasma. These methods are described below.

(a) Method of Heating in an Atmosphere Containing Oxygen Gas;

When the DLC film containing predetermined fine particles (at least one metal selected from Si, Al, Y and Mg or an alloy thereof) is heated in air or under an environment of an atmosphere containing oxygen gas, super-fine particles included in the DLC film are oxidized and changed from the surface of the film to form an oxide. Concretely, they are changed into chemically stable oxide of Si→SiO₂, Al→Al₂O₃, Y→Y₂O₃ or the like to develop the hydrophilicity. In this case, the upper limit of the heating temperature is 500° C. When the heating temperature exceeds 500° C., the DLC film consisting essentially of carbon and hydrogen is deteriorated. The hearting time is determined depending on the changing rate of the fine oxide particles included in the DLC film, but is for example, about 0.1 hr-10 hr. Moreover, when all of super-fine particles included in the DLC film are changed into oxide, if the heating time is elongated thereover, the DLC film may be deteriorated thermally.

(b) Method of Oxidizing by Oxygen Gas Plasma;

For example, when plasma is generated by using a plasma CVD apparatus of FIG. 4 and introducing an oxygen gas or a gas of Ar, He or the like containing oxygen gas as an atmosphere gas to negatively charge the substrate having the DLC film including the given super-fine particles (at least one metal selected from Si, Al, Y and Mg or an alloy thereof), the super-fine particles are gradually changed from the surface into the oxide due to the impact of excited oxygen ion. This method can put products immediately after the formation of the DLC film but also there is no fear of heating the DLC film, so that it is advantageous that the quality is stable and the productivity is improved as compared with the oxidation method under heating.

The amorphous DLC film formed by the aforementioned method and containing the metal oxide is confirmed that the film is wettable with water because the contact angle of the surface with droplet fallen thereon as measured for hydrophilicity is smaller by 34-42% that those of DLC film containing no metal oxide as described below.

Contact angle of DLC film containing metal oxide with water droplet: 15-20° (hydrophilicity)

Contact angle of DLC film containinmg no metal oxide with water droplet: 70-72° (lipophilicity)

Moreover, the content of the metal oxide fine particles co-precipitated into the DLC film is preferably 0.1-22 atomic %. When it is less than 0.1 atomic %, the control is difficult and sufficient effect is not obtained even if a slight amount of oxide particles is co-precipitated. When it exceeds 22 atomic %, there is no remarkable effect in the difference on the water wetting effect.

The fine particles of the metal oxide co-precipitated in the DLC film are excellent in the hydrophilicity, and hard and good in the abrasion resistance. FIG. 6 shows a section SEM image of a typical DLC film co-precipitated with SiO₂ fine particles.

The thickness of the DLC film formed on the roll substrate by any of the above methods is suitably within a range of 3-50 μm irrespectively of the presence or absence of the co-precipitation of the metal oxide fine particles. When the thickness of the DLC film is less than 3 μm, the engraving accuracy through laser beams at subsequent step is slightly lowered to shorten the life of the DLC film. While when it exceeds 50 μm, a long time is taken and the rise of production cost is caused.

(6) Finish Polishing Step;

The DLC film made on the roll substrate through the above steps is subjected to finish polishing by buffing, if necessary, as shown in FIG. 2, prior to the engraving through laser beams to form a smooth surface having a Ra value of not more than 0.013 μm. Particularly, when thick DLC film is formed, it is preferably subjected to this treatment. Of course, in case of the thin film, as long as it is not too thin, if the influence of minute projections of DLC component disruptively caused in the film formation is considered, the surface of the DLC film is preferably polished so as to finish into a surface roughness of Ra: not more than 0.013 μm and Rz: not more than 0.16 μm. This is effective to improve the engraving accuracy through laser beams at subsequent step but also to improve the groove-shaped accuracy of the concave portion for printing image area when the surface is smoothened to such a extent.

(7) Step of Engraving Through Laser Beams;

Laser beam-engraved grooves as a concave portion of printing image area are formed by irradiating laser beams to the surface of DLC film formed on the roll substrate through the above steps.

At this step, CO₂ laser, YAG laser or Ar laser is used as a laser source. The surface of the DLC film is subjected to an irradiation treatment with laser beams while rotating the roll or moving the laser heat source. This operation is carried out automatically by a computer in which laser beams are adjusted by lens in accordance with the size of the engraved groove (width, depth). As a result, the DLC film itself is locally heated by the laser beams, while only the overheated DLC film is vaporized and emitted in the form of gas such as CO₂, H₂O or the like into air, so that fused matter is not retained on the surface of the DLC film at all and the engraved grooves can be formed precisely and accurately.

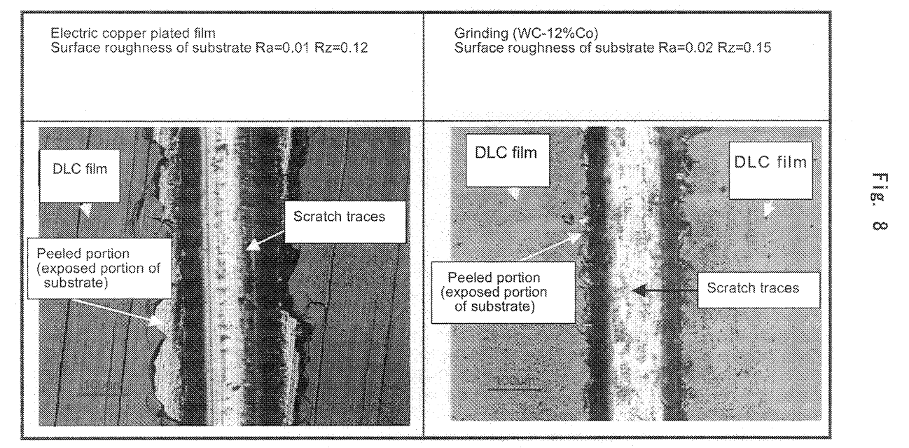

FIG. 7 shows an SEM image of an appearance of DLC film subjected to laser engraving by the method of the invention. As a laser source according to the invention those having the following specification are used, in which an output is relatively low as compared with those applied to metal or ceramic engraving:

Laser output: 50 W-1 kW

Pulse frequency: 10000 Mz-50000 Hz

Progression rate: 0.1-300 mm/min

### EXAMPLES

### Example 1

In this example, a coating is formed on an aluminum substrate by various methods, and thereafter a DLC film is formed on the surface of the coating, and then the adhesion strength of the DLC film is measured by a scratch test defined according to an adhesion test method of thin film on glass substrate of JIS R3255.

(1) Substrate

As a test piece substrate is used aluminum of 1050 grade defined in JIS H4000, which is cut into a test specimen of a size having width 50 mm×length 70 mm×thickness 5 mm.

(2) Film Forming Method and Kind of Coating

Onto one-side surface of the above A1 test specimen is formed a coating as a ground layer for DLC film by the following film forming method.

(i) Spraying method: WC-12 mass % Co, WC-20 mass % Ni-7 mass % Cr, TiC-20 mass % Ni, Cr₃C₂-20 mass % Ni-7 mass % Cr, Cu, Ni, Cr

Only Cr is by atmospheric plasma method, and others are by a high-speed flame spraying method, and the thickness of each film is 50 μm.

(ii) PVD method: Cr, Ar

A coating having a thickness of 3 μm is formed by a physical deposition method using electron beam source.

(iii) Electric plating method: Cu, Ni, Cr

A coating of 5 μm is formed by an electric plating method.

(3) Method of Forming DLC Film

A DLC film having a thickness of 5 μm is formed on each surface of the coatings by a plasma CVD method. In this example, a DLC film is directly formed on A1 test specimen as Comparative Example.

(4) Scratch Test

The scratch test is carried out according to an adhesion test method of a thin film using glass as a substrate defined in JIS R3255, in which a scratched state generated by moving a diamond needle while applying a load of 30 N to the needle is observed and recorded by a magnifying glass.

(5) Scratch Test Results

The results of the scratch test are summarized in Table 2. As seen from these results, the DLC films formed on the surfaces of Cu, Ni and Al are poor in the adhesion property irrespectively of any film forming methods such as spraying method, PVD method, electric plating method and so on and are easily peeled off. However, the DLC film formed on the Cr coating indicates a very good adhesion property even if the coating is formed by any film forming methods. Provided that Cr coating formed by the spraying method is porous, the DLC film formed on the coating is confirmed to be lacking in the smoothness because it exerts on the coating.

Since the Cr coating obtained by the PVD method or electric plating method is smooth, the DLC film formed on the coating is also smooth, which is sufficiently applicable for the object of the invention. However, it is poor in the productivity, and has a difficulty to the application to large members, and further the Cr coating by the electric plating has a problem in the safety and hygiene because Cr⁶⁺ is used in the production step.

On the contrary, the DLC films (No. 1-4) formed on the carbide cermet spray coating according to the invention indicate good adhesion property, and hence the phenomenon of peeling the DLC film is not substantially observed, and if the peeling is observed, it is very local and small area.

Moreover, FIG. 8 shows a typical appearance of scratch injury retaining on the DLC film after the scratch test.

TABLE 2

| | | | Material of | Scratch | |
|---|---|---|---|---|---|
| | | Coating | intermediate | test | |
| No. | Substrate | method | layer | result | Note |
| 1 | A1 (JIS | Spraying | WC—12Co | ◯ | Invention |
| 2 | H4000 | | WC—20Ni— | ◯ | Example |
| | 1050) | | 7Cr | | |
| 3 | | | TiC—20Ni | ◯ | |
| 4 | | | Cr₃C₂—20Ni— | ◯ | |
| | | | 7Cr | | |
| 5 | | | Cu | X | Comparative |
| 6 | | | Ni | X | Example |
| 7 | | | Cr | ◯ | |
| 8 | | PVD | Cr | ◯ | |
| 9 | | | Al | Δ | |
| 10 | | Electric | Cu | X | |
| 11 | | plating | Ni | X | |
| 12 | | | Cr | ◯ | |
| 13 | | none | none | X | |

(Note)
(1) Tests No. 1-6 in the spraying method are high-speed flame spraying methods, and No. 7 is atmospheric plasma spraying method.
(2) Test results in column of material of intermediate layer
◯: good adhesion property though injury is generated
Δ: generation of slight peeling
X: large peeling

### Example 2

In this example, water-wetted state of DLC film co-precipitated with various metal oxides is examined, while the soundness of the DLC film is evaluated by subjecting the test specimen formed with the DLC film at a folded state of 90° to a salt spray test.

(1) Spray Coating as a Test Substrate

As a test substrate is used SK steel, from which is cut out a test specimen having a size of width 30 mm×length 70 mm×thickness 3 mm, and only one-side surface thereof is roughened by plasma working and thereafter a coating of WC-20Ni-7Cr (numeral value is mass %) is formed at a thickness of 80 μm by high-speed flame spraying method. Further, the surface is subjected to finish polishing of Ra: 0.5-0.8 μm.

(2) Properties of DLC Film

The following metal is co-precipitated into the DLC film over a full surface of the spray coating in the test specimen and then oxidized by an oxygen plasma treatment to form an oxide film having a thickness of 3 μm.

(a) Kind of co-precipitating oxide and co-precipitated state

Single oxide: SiO₂, Y₂O₃, Al₂O₃, MgO

Composite oxide: SiO₂/Y₂O₃, SiO₂/Al₂O₃, Al₂O₃/Y₂O₃

Moreover, the content of the single oxide or composite oxide in the DLC film is 0.5 atomic %, and the ratio of the two metal oxides in the composite oxide is 1:1.

Also, the hydrogen content in the DLC film is 20 atomic % and the reminder is carbon.

(3) Test Methods

(a) Water-wetting test: The water wetting test is carried out by dropping tap water on the surface of the test specimen and visually observing water wetted state on the surface of the DLC film.

(b) Test for corrosion resistance: The test specimen is folded from its central portion at 90° and then subjected to a salt spray exposure test defined in JIS ZZ2371 for 96 hours to research the presence or absence of red rust.

(4) Test Results

The test results are summarized in Table 3. As seen from the test results, water dropped on the DLC film co-precipitated with fine particles of the metal oxide is wetted over its full surface, whereas the generation of red rust is not observed on the DLC film even when the DLC film not co-precipitated with the oxide is folded at 90° as a contact angle and subjected to the salt spray exposure test as it is. From these results, it has been confirmed that the DLC film formed on surface of the carbide cermet spray coating and co-precipitated with fine particles of the oxide does not cause cracking and peeling phenomenon in the film itself and has a corrosion resistance equal to that of the DLC film containing no oxide film even if being subjected to some deformation.

TABLE 3

| | | | | | | Test results | | |
|---|---|---|---|---|---|---|---|---|
| | | Surface roughness of spray | | | | Water | Salt spray | |
| | | coating (μm) | | Co-precipitated oxide | | wetting | exposure | |
| No. | Substrate | Ra | Rz | component | mixing ratio | test | test | Remarks |
| 1 | SK steel | 0.07 | 0.09 | SiO₂ | — | ◯ | ⊚ | A |
| 2 | | 0.08 | 0.11 | Y₂O₃ | — | ◯ | ⊚ | A |
| 3 | | 0.09 | 0.15 | Al₂O₃ | — | ◯ | ⊚ | A |
| 4 | | 0.05 | 0.90 | MgO | — | ◯ | ⊚ | A |
| 5 | | 0.06 | 0.91 | SiO₂/Y₂O₃ | 1/1 | ◯ | ⊚ | A |
| 6 | | 0.08 | 0.95 | SiO₂/Al₂O₃ | 1/1 | ◯ | ⊚ | A |
| 7 | | 0.27 | 0.82 | Al₂O₃/Y₂O₃ | 1/1 | ◯ | ⊚ | A |
| 8 | | 0.05 | 0.33 | none | none | X | ⊚ | B |
| 9 | | no film | no film | none | none | X | ⊚ | B |

(Note)
(1) Test substrate: SK steel Size: width 30 mm × length 70 mm × thickness 1.8 mm
(2) Spray coating: WC—20Ni—7Cr, high-speed flame spraying method thickness: 80 μm
(3) DLC film thickness: 3 μm
(4) Amount of metal oxide co-precipitated in DLC film: 0.5 atomic %
(5) Evaluation of test result
◯: totally uniform water wetting
⊚: no generation of red rust
X: local water wetting
(6) Column of Remarks
A: Invention Example
B: Comparative Example

### Example 3

In this example, lipophilicity (hydrophobicity) and hydrophilicity (lipophobicity) are given to the DLC film according to the invention to research wetting state of water and oil against the film surface.

(1) Test Substrate and Spray Coating

As a test substrate is used SUS 304 steel, from which is cut out a test specimen having a size of width 50 mm×length 100 mm×thickness 3.2 mm, and thereafter only one-side surface thereof is subjected to a plasma roughening treatment and then a WC-12 mass % Co cermet coating of 100 μm in thickness is formed on the roughened surface by a high-speed flame spraying method. Further, the surface of the spray coating is finished to Ra: 1.1-1.4 μM and Rz: 5-9 μm.

(2) Properties of DLC Film

On the surface of the spray coating is formed a DLC film at a thickness of 5 μM, and then the DLC film is changed into hydrophilicity by subjecting to a treatment as mentioned below:

(a) hydrophobic DLC film: film comprising hydrogen content of 18 atomix % and the reminder of carbon;

(b) hydrophilic DLC film: film formed by co-precipitating 1.2 atomic % of SiO₂ as an example of metal oxide on the surface of the DLC film.

(3) Test Method

An aqueous slurry polishing agent containing colloidal silica is applied dropwise to the surface of the DLC film of the test specimen, which is placed in a hot air furnace of 90° C. to evaporate only water. Thereafter, the distribution state of colloidal silica particles retaining on the surface of the DLC film is observed by a magnifier with 20 magnification to compare quality of water wetting. The reason why this method is adopted is due to the fact that it has been confirmed by preliminary experiments that the colloidal silica particles are necessarily retained in the existing places of the aqueous slurry polishing agent after the evaporation of water and the water wetting degree can be seen by equalization of the retaining distribution amount or the like.

(4) Test Results

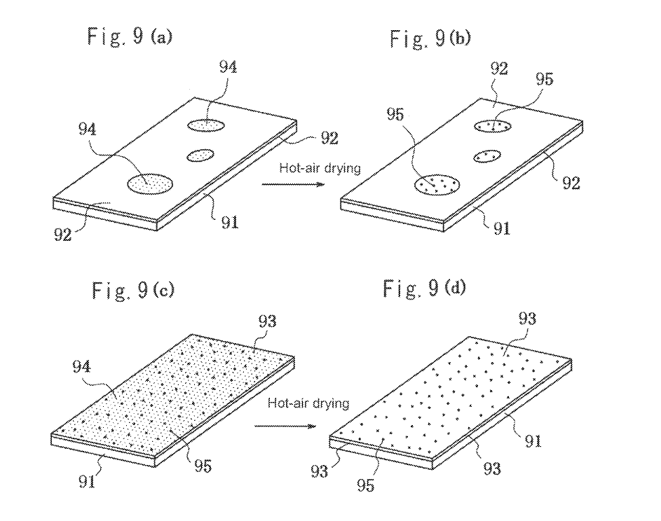

The test results are summarized in Table 4. As seen from the test results, when the aqueous slurry polishing agent is added dropwise over the full surface of the DLC film containing no SiO₂ particles, which indicate hydrophobicity, it is dispersed in form of small and large water puddles immediately. Thereafter, solid-like colloidal silica fine particles locally remains in the hydrophobic DLC film after the evaporation of water in the hot air furnace, and it has been confirmed that the water wetting area is small and irregular distribution state is existent. On the contrary, colloidal silica is equally distributed over the full surface of the DLC film with hydrophilicity suitable for the invention. FIG. 9 shows schematically the above phenomenon of the aqueous slurry polishing agent. At this moment, FIG. 9(a) shows a state of adding an aqueous slurry polishing agent 94 to be dropped on the surface of the hydrophobic DLC film 92 in which the added aqueous slurry polishing agent 94 is locally dispersed on the substrate 91 in form of large and small puddles. FIG. 9(b) shows a case that the test specimen of this state is heated to a temperature of 90° C. to evaporate water. In this case, it has been found that white colloidal silica fine particles 95 remain concentrated only in the existed places of the slurry polishing agent.

On the other hand, FIG. 9(c) shows that the aqueous slurry polishing agent 94 is added to be dropped on the DLC film 93 imparted with hydrophilicity by co-precipitating SiO₂ particles in the DLC film, in which the whole of the DLC film 92 is at a good wetted state. When it is dried, colloidal silica particles are also equally distributed on the full surface of the DLC film 93 as shown in FIG. 9(d). Moreover, 91 is a substrate, 92 a DLC film, 93 a DLC film containing SiO₂ particles, 94 an aqueous slurry polishing agent containing colloidal silica, and 95 colloidal silica particles retaining on the DLC film after the evaporation of water.

TABLE 4

| | | Roughness of spray | | | Test results of DLC film | | |
|---|---|---|---|---|---|---|---|
| | | coating (μm) | | | Wetting of | Distribution of | |
| No. | Substrate | Ra | Rz | DLC film | aqueous slurry | colloidal silica | Remarks |
| 1 | SUS304 | 0.06 | 0.2 | hydrophobic | local | local | Invention |
| | | | | | | | Example |
| 2 | | 0.07 | 0.9 | hydrophilic | full | full surface | Invention |
| | | | | (SiO₂) | surface | | Example |

(Note)
(1) The surface roughness of the substrate is measured at 3 places per test. Ra shows an average value, and Rz shows a maximum value.

Moreover, when the wetting property of the DLC film is researched with an oil (machine oil) instead of water, an oil film is equally existent on the full surface of the hydrophobic DLC film, but the equal wetting property of the oil film can not be observed on the hydrophilic DLC film containing SiO₂.

As seen from the above results, the DLC film according to the invention can give good wettability to both of oil-base and water-base printing inks.

### INDUSTRIAL APPLICABILITY

The technique of forming engraved grooves on the DLC film through laser beam irradiation according to the invention is sufficiently applicable to letterpress, lithography, stencil and non-plate systems in addition to the gravure engraving. Also, the form of the substrate may be flat plate in addition to the roll. For example, the DLC film may be formed on the surface of glass, plastic or the like, so that after the formation of the DLC film on these surfaces, it is subjected to laser beam work to form a printing plate, or it is possible to fabricate new art products by retaining various coloring inks on the engraved portions. Furthermore, after the DLC film is formed on a sliding part of a bearing, shaft or the like in machineries, a helical groove may be formed on the film through laser beams to use as a pathway of a lubricant.

1. A printing roll comprising a roll substrate, a carbide cermet spray coating formed on the surface of the roll substrate and a DLC film layer formed on the surface of the carbide cermet spray coating and having laser beam-engraved grooves as a concave portion for printing image area.

2. A printing roll according to claim 1, wherein the DLC film is provided with hydrophilicity by including 0.1-22 atomic % of fine oxide particles of at least one metal selected from Si, Y, Al and Mg.

3. A printing roll according to claim 1, wherein the DLC film has a thickness of 3-50 μm, a chemical composition of carbon: 70-88 atomic % and hydrogen: 12-30 atomic % and a hardness Hv of 700-3000.

4. A printing roll according to claim 1, wherein the DLC film having laser beam-engraved grooves has a residual stress of less than 1.0 GPa.

5. A printing roll according to claim 1, wherein the DLC film has Ra≦0.013 μm and Rz≦0.16 μm as a roughness of a finish polished surface.

6. A printing roll according to claim 1, wherein the carbide cermet spray coating contains 95-70 mass % of at least one metal carbide selected from WC, TiC, Cr₃C₂ and MoC and 5-30 mass % of at least one metal selected from Ni, Cr, Mo, Co and Al.

7. A method for producing a printing roll, which comprises roughening a surface of a roll substrate by blast process; forming a carbide cermet spray coating on the roughened surface by spraying process; grinding or grinding-polishing the surface of the carbide cermet spray coating; forming a DLC film on the ground or ground-polished surface of the carbide cermet spray coating; and engraving the surface of the DLC film through laser beams to form laser beam-engraved grooves as a concave portion for printing image area.

8. A method for producing a printing roll according to claim 7, wherein the DLC film is provided with hydrophilicity by including 0.1-22 atomic % of fine oxide particles of at least one metal selected from Si, Y, Al and Mg.

9. A method for producing a printing roll according to claim 7, wherein a surface roughness of the roll substrate roughened by blast process is adjusted to Ra: 5-12 μm and thereafter a carbide cermet spray coating containing 95-70 mass % of at least one metal carbide selected from WC, TiC, Cr₃C₂ and MoC and 5-30 mass % of at least one metal selected from Ni, Cr, Mo, Co and Al is formed on the roughened surface.

10. A method for producing a printing roll according to claim 7, wherein the surface of the carbide cermet spray coating is made to Ra: 0.05-8.00 μM and Rz: 0.5-20 μm by grinding or grinding-polishing.

11. A method for producing a printing roll according to claim 7, wherein the DLC film has a thickness of 3-50 μm, a chemical composition of carbon: 70-88 atomic % and hydrogen: 12-30 atomic % and a hardness Hv of 700-3000.

12. A method for producing a printing roll according to claim 7, wherein the surface of the DLC film is finish polished to approximately a roughness of Ra≦0.013 μm and Rz≦0.16 μm,

13. A method for producing a printing roll according to claim 7, wherein the DLC film is engraved as a concave portion for printing image area with a heat source of at least one laser beam selected from CO₂ laser, YAG laser, Ar laser and excimer laser.

14. A method for producing a printing roll according to claim 7, wherein the DLC film has a residual stress of less than 1.0 GPa.
